(19) United States
(12) Patent Application Publication
(10) Pub. No.: US 2006/0219794 A1
(43) Pub. Date: Oct. 5, 2006

(54) Digitally printed folded lottery ticket

(76) Inventors: Neil Ellis, St. John's, (CA); Joseph E. Harrison, University Heights, OH (US)

Correspondence Address: PEARNE & GORDON LLP, 1801 EAST 9TH STREET, SUITE 1200, CLEVELAND, OH, 44114-3108, US

(21) Appl. No.: 11/385,090

(22) Filed: Mar. 21, 2006

Related U.S. Application Data
(60) Provisional application No. 60/663,824, filed on Mar. 21, 2005.

(51) Int. Cl. G06K 19/00; G06F 15/12; A63F 9/24

(52) U.S. Cl. 235/487; 235/432; 463/22

(57) ABSTRACT

Provided is a ticket for a game of chance. The ticket includes a strip having a first fold and a second fold. The first fold defines a first panel at an end of the strip. The second fold defines a second panel at another end of the strip. A third panel is located between the first panel and the second panel. A play combination is located on the third panel on a first side of the strip. Game identifying information is located on the first panel on a second side of the strip. The first panel is folded over the second panel to form an unopened position.

### CROSS-REFERENCE TO RELATED APPLICATIONS

Benefit of U.S. Provisional Patent Application Ser. No. 60/663,824, filed Mar. 21, 2005, is hereby claimed and the disclosure incorporated herein by reference.

### BACKGROUND OF THE INVENTION

1. Field of the Invention

The present invention relates to tickets for a game of chance, and more particularly to digitally printed folded tickets for a game of chance, amusement, promotional, or advertisement purposes.

2. Description of Related Art

Jar tickets are folded tickets for a game of chance. They are small, paper, folded and banded tickets that are purchased by a player for a predetermined amount. They are typically stored in a jar or other receptacle prior to purchase by a player. They can be produced and purchased in a single ticket format or bundled in groups, such as groups of 2, 3, 4, 5 or 10's. Tickets can be stapled or glued together when in bundles. The jar ticket is traditionally a single ply folded and banded paper ticket, featuring symbols, letters or numerals. Tickets can be sold to a player in bundles or mounted on a board. Players reveal the symbols by ripping or breaking open the ticket from a banded bond.

After the player opens the banded section to reveal the symbol(s), they compare the ticket to a “flare” or display card to determine if they have a winning or losing ticket. The flare, which is enclosed with each set of game tickets, illustrates the pre-determined winning symbol(s), letter(s) or number(s), their associated prize amounts and the quantity of each contained in the set. The flare card also specifies the game name, cost per ticket to players, the manufacturer's form number and set serial number.

Jar tickets are often not used in the charitable bingo games and state lottery games because their small size and non-sequential packaging makes it difficult to track and sell them.

Break-open tickets are constructed of two plys of material connected together by adhesive with perforated windows on one side that break-open when the ticket is played. Break-open tickets often have multiple play combinations on a single ticket. Break-open tickets are often used in the charitable bingo games and state lottery games. The size and construction of a break-open ticket is more conducive to handling and tracking of product during its pre-sale and sale than that of a jar ticket. Traditionally break-open tickets are packaged in sets of 100 with an elastic band around them for easy counting.

Traditional gaming tickets are manufactured in a sheet-fed printing plant using multiple printing plates of static images to produce press sheets. Normally, there are a limited number of press sheets produced to make a volume of tickets because each press sheet requires a plurality of plates and additional set-ups and wash-ups on the printing press. This process can be expensive, which may make it uneconomical to produce small quantities of tickets or completely unique sets of tickets. In the traditional process, the use of serial numbers is important to differentiate a ticket from one set from a ticket from a different set, primarily because each set of tickets in a specific product are exactly the same but shuffled into a different order. In some instances, gaming tickets make use of a variable print technology that depend on the use of databases at the time of printing to randomize the product. This method of manufacture is still not utilized to its full capacity because of the high cost of variable printing and the low quality of the printed images.

### BRIEF SUMMARY OF THE INVENTION

In accordance with one aspect of the present invention, provided is a ticket for a game of chance. The ticket includes a strip having a first fold and a second fold. The first fold defines a first panel at an end of the strip. The second fold defines a second panel at another end of the strip. A third panel is located between the first panel and the second panel. A play combination is located on the third panel on a first side of the strip. Game identifying information is located on the first panel on a second side of the strip. The first panel is folded over the second panel to form an unopened position.

A method for printing a plurality of randomized tickets for a game of chance. The method includes the steps of providing data to a printer, wherein the data includes a digital press sheet that includes the randomized tickets, and printing the digital press sheet onto a substrate so that the randomized tickets are printed onto the substrate.

### BRIEF DESCRIPTION OF THE DRAWINGS

FIG. 1 shows front and rear elevation views of a game ticket;

FIG. 2 shows a front elevation view of a game ticket;

FIG. 3 shows a front elevation view of a game ticket;

FIG. 4 shows a front elevation view of a game ticket;

FIG. 5 shows a front elevation view of a game ticket;

FIG. 6 shows a perspective view of a game ticket;

FIG. 7 shows a perspective view of a game ticket;

FIG. 8 shows a perspective view of a game ticket in an unopened position;

FIG. 9 shows a perspective view of a game ticket in an unopened position; and

FIG. 10 shows a digital press sheet.

### DETAILED DESCRIPTION OF THE INVENTION

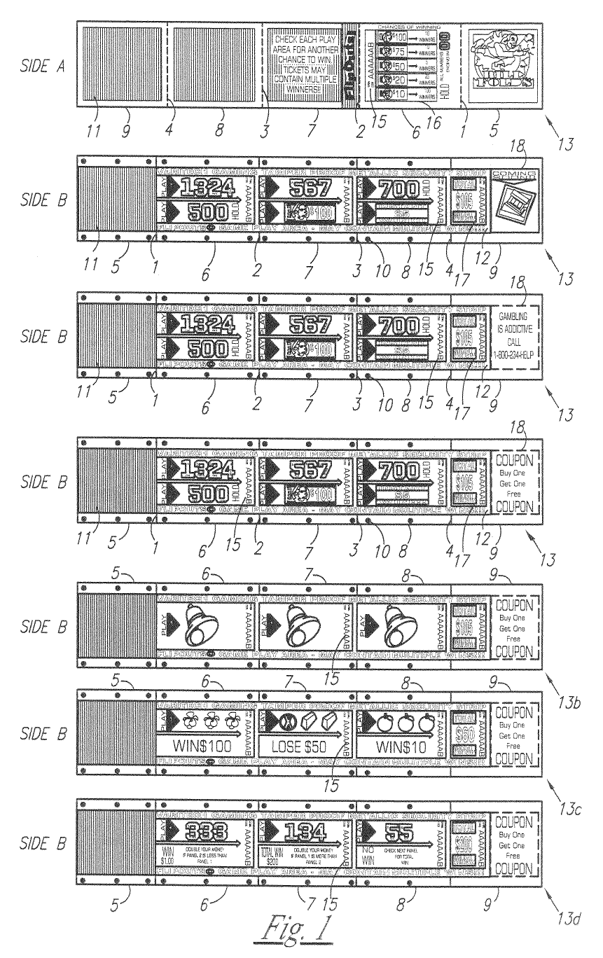

Described herein is a ticket for amusement purposes, advertisement purposes, promotional purposes and/or a game of chance, such as a lottery, and a method of manufacturing said ticket. In FIG. 1, it can be seen that the ticket 13 includes two sides, an “A” side and a “B” side. Side A is the rear side of the ticket 13 and side B is the front side of the ticket 13. In an embodiment, the ticket 13 is constructed from a single-play material, such as paper or card stock, and includes printing on both sides of the single-ply material. In an embodiment, the ticket 13 forms an elongated strip wherein the strip's length exceeds its height. The height of the ticket 13 can be any desired height, for example, 3.75 inches, 3 inches, 2.5 inches, 2 inches, 1.5 inches, 1 inch, 0.75 inches, or 0.5 inches. A series of folds along fold lines 1, 2, 3, 4 divide the ticket into several panels 5, 6, 7, 8, 9. The ticket 13 is shown in an unfolded or completely opened position

Panel 5 is an identification panel. Printed on side A of the identification panel 5 is the game's name and form number. For example, the game shown in FIG. 1 is called “BILL FOLDS” and has form number 12345. The form number corresponds to the name of the game, the number of tickets in the game and the game's payout. The form number functions as a model number.

Panels 6, 7 and 8 are game panels. Printed on side B of the game panels 6, 7, 8 are play combinations that can include symbols, characters, images, numbers or other markings that provide winning or losing game plays. Game plays can also include an instant win indication, as can be seen in game panel 8. In FIG. 1, each game panel, 6, 7 and 8 includes two play combinations or one play combination and one instant win indication, for a total of six plays on the ticket 13. A ticket 13 can include any number of game panels, for example, one, two, or three or more game panels. A ticket 13 can include any number of game plays per game panel, such as one game play per panel, more than one game play per panel, or combinations of single and multiple game plays per panel on one ticket 13.

A code, for example a serial number or alphabetic serial code 15 is printed on each game panel 6, 7 and 8. The alphabetic serial code 15 is a series of letters that uniquely identifies a particular deal of a game. For example, the same form number may be repeatedly printed and played, that is, dealt, over a given period of time. However each repetition has a unique alphabetic serial code 15 so that only winning tickets for that deal, bearing the correct alphabetic serial code 15, can be used to collect a prize. By printing the alphabetic serial code on each game panel 6, 7, and 8, a winning ticket can be accidentally or intentionally ripped, for example, ripped along a fold line 1, 2, 3, 4, and a winning portion of the ticket 13 submitted to claim a prize.

Printed on side A of game panel 6 is the alphabetic serial code 15, which is visible when the ticket 13 is folded up along fold lines 1, 2, 3, 4 as described further below. Also printed on side A of game panel 6 are the game's payout scheme and winning symbols 16.

Printed on side B of panel 9 is a winner/loser and total win indication 17. Further printed on side B of panel 9 is an advertisement, coupon, or other message, such as a message regarding a charity 18. For example, panel 9 can include a warning message about compulsive gambling and/or information about sources of help for compulsive gamblers. Panel 9 can include one or both of the advertisement, coupon, or other message 18 and the winner/loser and total win indication 17. In an embodiment, panel 9 is not provided and the ticket 13 includes an identification panel 5 and one or more game panels 6, 7, 8. In an embodiment, the advertisement, coupon, or other message extends inward from an end of the ticket 13 to at least 0.25 inches from the end.

The ticket 13 is folded up prior to playing to form an unopened position and held shut by glue, for example, fugative glue 10. The glue 10 may be placed on the ticket 13 in dots, lines or other configurations. The ticket 13 may also be held shut by other methods including crimping, stapling and banding. The ticket 13 is folded up by panel 9 being folded over panel 8 along fold line 4. Then panels 9 and 8 are folded over panel 7 along fold line 3. Then panels 9, 8 and 7 are folded over panel 6 along fold line 2. Then panel 5 is folded over panels 6, 7, 8 and 9 along fold line 1 and glued to side A of panel 7. When the ticket 13 is completely folded up prior to playing, side A of panels 5 and 6 are visible, along with part of side A of panel 7. Panel 5 is not as wide as panels 6, 7, 8 and 9 and, therefore, does not completely cover panel 7 when folded over and glued to panel 7.

The ticket is played by unfolding the ticket in a manner opposite from the folding process described above.

The ticket 13 includes a blockout area 11, which can be formed by printing one or more colors on top of each other to increase the opacity of a portion of the ticket 13 and reduce the ability of light to pass through the folded ticket 13.

In an embodiment, one or more panels of the ticket 13 include printing 12 that defines a perimeter area within a panel. For example, the perimeter area 12 can surround the play combinations within a game panel. The perimeter area 12 is printed with a metallic ultra violet (UV) ink and/or coating that acts as a security strip, and which will stop the glue 10 from bleeding into the play area and hinder the ability for duplicating of the ticket 13 on a photocopier. Wording can be applied to the UV metallic ink security strip to ensure that a ripped ticket is re-assembled in a correct order.

In addition to the embodiment described above, FIG. 1 shows a ticket 13b having a single play combination of three symbols spread over several game panels 6, 7, 8.

FIG. 1 further shows a ticket 13c having a progressive/digressive play scheme in which successive game panels provide increased or decreased winnings. Game panel 6 shows a play combination that results in a $100 win. However, game panel 7 shows a play combination that results in a $50 loss. Game panel 8 shows a play combination that results in a $10 win. A total win of $60 is displayed in panel 9, which is the sum of the winnings and losses provided by all of the game panels 6, 7, 8.

FIG. 1 further shows a ticket 13d having a progressive play scheme in which a condition provided in one game panel must be met by another game panel to result in increased winnings. For example, game panel 6 provides that a $100 win will be doubled if the play combination of game panel 7 is less than the play combination of game panel 6. Because the play combination of game panel 7 is less than the play combination of game panel 6, game panel 7 provides an indication that the total winnings have been doubled to $200. Game panel 7 provides that the $200 win will be doubled if the play combination of game panel 8 is more than the play combination of game panel 7. Because the play combination of game panel 8 is less than the play combination of game panel 7, game panel 8 provides an indication that there is no increase in winnings. Panel 9 provides a total win indication of $200. In an embodiment, game panels 6, 7, 8 include conditions that, if met, result in decreased winnings. In an embodiment, if the condition for a game panel 6, 7, 8 is not met by another game panel, then there is a win of $0 for said game panel 6, 7, 8.

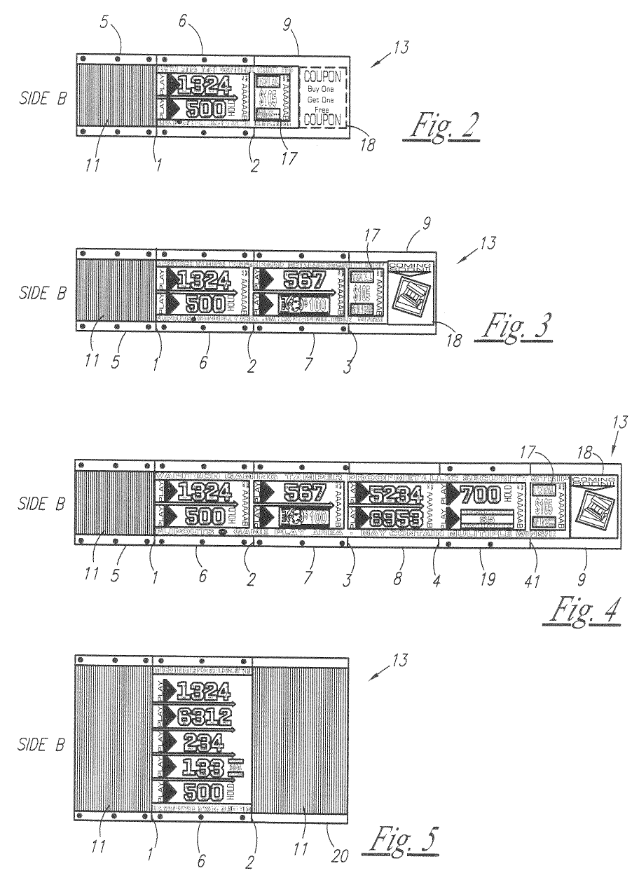

FIG. 2 shows side B of a ticket 13 having an identification panel 5 with block out area 11, a single game panel 6 with two play combinations on the game panel 6, and a panel 9 that includes a winner/loser and total win indication 17 and a coupon 18. The ticket 13 includes fold lines 1, 2 that divide the ticket 13 into panels 5, 6, 9.

FIG. 3 shows side B of a ticket 13 having an identification panel 5 with block out area 11, two game panels 6, 7 with two play combination on each game panel 6, 7, and a panel 9 that includes a winner/loser and total win indication 17 and an advertisement 18. The ticket 13 includes fold lines 1, 2, 3 that divide the ticket 13 into panels 5, 6, 7, 9.

FIG. 4 shows side B of a ticket 13 having an identification panel 5 with block out area 11, four game panels 6, 7, 8, 19 with two play combination on each game panel 6, 7, 8, 19 and a panel 9 that includes a winner/loser and total win indication 17 and an advertisement 18. The ticket 13 includes fold lines 1, 2, 3, 4, 41 that divide the ticket 13 into panels 5, 6, 7, 8, 19, 9.

FIG. 5 shows side B of a ticket 13 having an identification panel 5 with block out area 11, a single game panel 6 with five play combinations on the game panel 6, and a panel 20 with a block out area 11. The ticket 13 includes fold lines 1, 2 that divide the ticket 13 into panels 5, 6, 20.

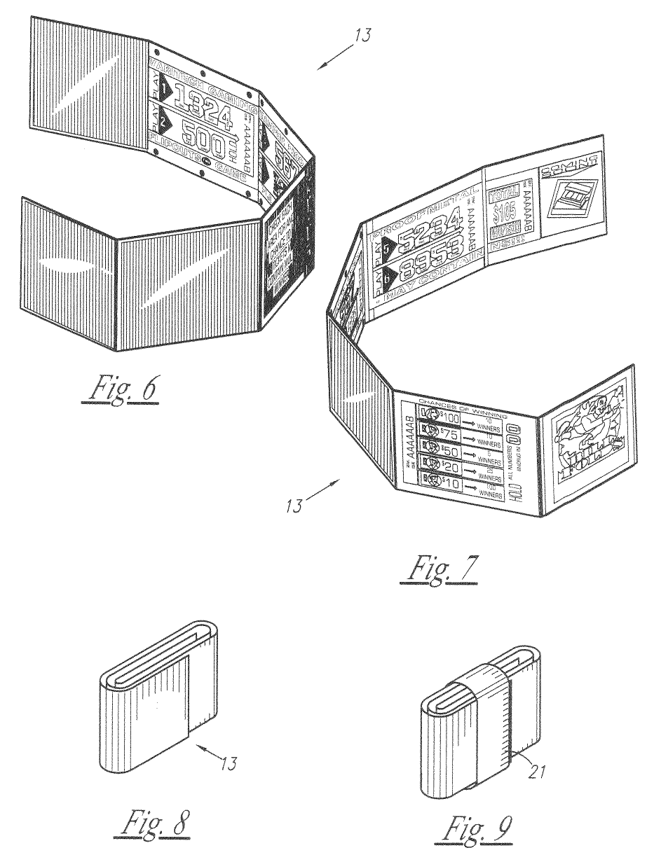

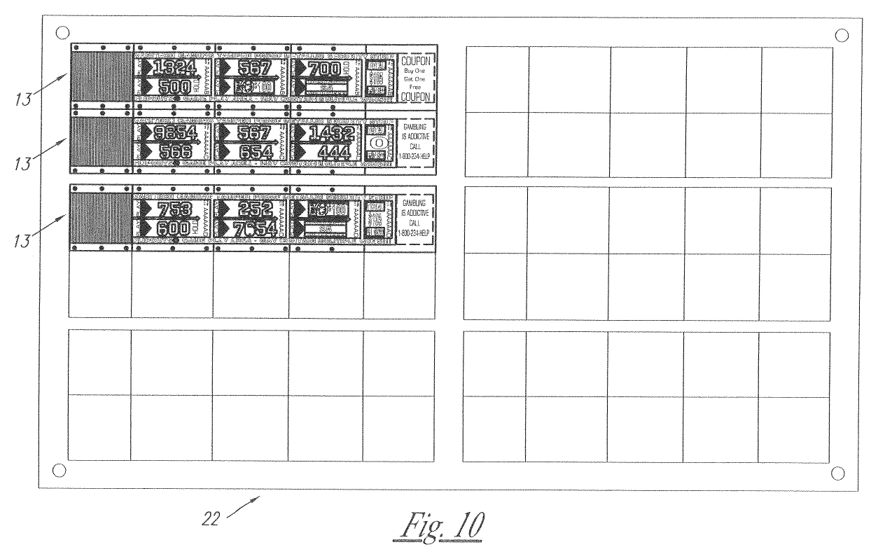

FIG. 6 and FIG. 7 each show perspective view of a substantially unfolded ticket 13. FIG. 8 shows the ticket 13 folded up into the unopened position. As discussed above, the ticket 13 can be held in the unopened position by glue. The ticket 13 can also be held in the unopened position by stapling or crimping, for example, crimping along one or more of the folded ticket's 13 edges. As shown in FIG. 9, the ticket 13 can also be held in the unopened position by a band 21 wrapped around the folded ticket 13.

The ticket 13 can be constructed so that it can be played in both the traditional jar ticket market as well as the break-open ticket market. It can be constructed from heavier paper stock than a jar ticket but lighter than a break-open ticket. Tickets 13 can be packaged and sold in a receptacle, such as a jar or a bag, or assembled in a joined set, such as a banded set of 100 tickets, for example.

The multi-fold design of the ticket 13 allows for a single play ticket with increased play value or a multi play ticket with multiple chances of winning. Tickets 13 having a single game panel 6, such as those of FIG. 2 and FIG. 5, can be constructed with a card stock similar to a break-open ticket to match the size and feel of a break-open ticket but with a unique flip open style. The multi-fold ticket 13 also allows for a self-promotion or advertising panel at one end of the ticket, which is viewable after the ticket is completely open. This panel will provide increased value to the marketers by giving the ability to advertise new games, provide charitable messages, as well as relationship marketing techniques like a mail in coupon.

A method for manufacturing the ticket 13 discussed above will now be described.

The ticket 13 disclosed herein will take advantage of traditional printing for portions of the ticket that are static but incorporate digital printing for other portions, such as gaming and advertising portions. For example, portions of the ticket that are static, that is, portions that are the same from ticket-to-ticket can be printed using traditional plate-based static printing techniques. Portions that change from ticket-to-ticket can be printed using digital printing techniques discussed in detail below. Alternatively, all portions of the ticket can be printed using digital printing techniques without using any traditional plate-based static printing techniques.

As used herein, the terms “digital printing” and “digital printing techniques” refer to printing processes in which data is provided to a printer, such as via a downloaded file. The printer then prints an image or images based on information contained in the provided data.

The digital printing portions of the ticket 13 are not printed using variable data printing in which databases of symbols must be used to populate the print stream during the process of printing. Instead, a data file is provided to the printer. The data in the file represents a full game set to be printed onto one or more sheets of paper, card stock, etc. The game set is already randomized when the data file is provided to the printer. The printer does not randomly print play combinations selected from a database, but prints the full, already randomized game set from the provided data file.

The data, which represents a full game set, provides a collection of viewable digital press sheets that can be viewed using an appropriate software package. The digital press sheets can be viewed electronically and checked/verified prior to printing. In an embodiment, the data is in the form of a PORTABLE DOCUMENT FORMAT (.pdf) file and can be viewed via the ADOBE READER software package.

A method for creating digital press sheets will now be described. An example digital press sheet 22 having three tickets 13 can be seen in FIG. 10.

A game symbol set is picked from a pre-determined set of ticket symbol sets, or a new set is developed and entered into a database. The game rules are set by the operator of a program for generating digital press sheets, which includes factors such as what constitutes a winning or losing play combination and the number of tickets in a game set. Other rules may include special symbols or number combinations that would be omitted, for example, per a customer request.

The program then goes into a loop that will create one ticket at a time and compare it against the rules that have been set. If the ticket passes the rules test it is stored and the number of need tickets is decreased by one. If the ticket fails the test it is discarded and a ticket counter does not advance.

Once a game set has been generated, the program creates a random placement list. This is a table of data that reorders the ticket output for subsequent game. This allows for per-ticket tracking for easy reprinting or checking. Each list can be identified by the batch serial number allowing for easy retrieval of the data.

Next the individual tickets are generated and saved in a folder. Each ticket's data is read from the database and the ticket symbols are arranged on the digital press sheet template and saved. These tickets are used in the next phase of the process. Generating tickets in this manner reduces the processing time because the tickets need only be created once.

The process continues with the creation of single or multi page .pdf documents. Each page of the .pdf document contains at least one and preferably contains at least 2 or more tickets. The process is done by loading a placement list and using it to determine the order in which the pre-generated tickets are imposed onto the digital press sheet. The placement and number of tickets placed on the press sheet is determined by a calculation based on the size of the final press sheet and the number of tickets that can fit on the preset size. Each placement list is processed in the same manner thus giving each box of tickets a unique ticket order. In this phase the serial number or alphabetic serial code is applied, the correct serial number is always used because the only number available is the one stored with the placement list.

The .pdf documents are digitally stored as complete press sheets for printing on the digital printer/press. Once the .pdf document is complete, no further randomization of ticket placement on the press sheet occurs. Each digital press sheet can be printed off for final customer approval before the printing process and all approved press sheets can then be printed on the digital printer based on the operators instructions to download specific sheets to the digital printer. The operator can choose to print a complete multipage file on the printer with a full or partial game set or he/she can choose to print single pages.

Digital press sheets are not limited to any particular file format. All acceptable storage formats including, .pdf, 1 bit tiff, jpg, tif, postscript, ppml, xml, or any other digital formats that can be used to store a set of tickets digitally in a pre-set sequence on a page is included in this method of printing tickets.

It is important to note that the process discussed above for creating digital press sheets does not interact directly with the digital printer and singe tickets are not sent to the printer in random format for population on the Raster Image Processor (RIP) of the digital printer/press. Our process creates the final digital press sheet before the data is sent to the RIP allowing for customer verification and approval. Absolutely no variable data is applied to the press sheets after the sheets have been generated.

This sytem allows for easy duplication of a game set during a subsequent printing. Digital press sheets can eliminate the need for multiple films and plates and press runs. The pre-generation of digital press sheets into multi-page documents will allow for the printing of one set of tickets for review and approval before printing a full game set or printing just the game and advertising information for that set of tickets onto an approval proof sheet for the customer to approve before the job is printed. The use of online digital sign-offs by a customer on complete ticket sets can also be accomplished.

Digital press sheets, in single page or multi-page format, having a ticket or tickets imposed on each sheet can be downloaded to the printer in the page description format of that printer. Example page description formats include postscript, pcl, ppml, xml, and other page description formats used to describe to the digital printer how to image the contents of the data file to the substrate media on which printing is to occur. Digital press sheets can be provided in other formats, such as bitmapped formats or vector-based formats, for example. In some instances the complete ticket will be digitally printed including all information included on both sides of the ticket, and no portion of the ticket will be printed statically.

The printing of a data file discussed above differs from a variable print process in that variable printing requires a database that is accessible by a printer at the time of printing. Population of a game ticket with various play combinations happens at the time of actual printing via the printer's accessing of the database, so customer pre-approval of a game set cannot be achieved. Database errors can occur and an incorrect ticket set can be produced and sealed with no digital verification. Digital construction of press sheets into multi-page files ensures that all game sets can be checked and approved before the digital press is used to apply the data.

The static portion of the printing can be applied using traditional forms of printing such as offset or flexo printing. In some instances rolls of paper are pre-printed on a web press and in other instances sheet-fed presses are used. This portion of the printing may require films, plates or digital plates. On one side of the ticket, the ticket identification information is pre-printed. On the other side of the ticket a blockout portion is printed along with a metallic ink security strip to discourage photocopy duplication of the ticket. The blockout portion will be printed with one or more colors printed on top of each other to form a substantially or completely opaque barrier. One of the colors used may be a metallic ink to provide further opacity as well as further security features. In some instances, the security blockout area can be printed on the identification side of the ticket and/or on the game play and advertising side of the ticket. UV inks can be used in the static printing process. UV inks sit on top of the paper and are generally more opaque than traditional offset and waterbased inks. Glue does not stick to UV ink, so when the glue is applied to seal the tickets, the metallic security strip 12 on side B of ticket 13 will act as a barrier for the glue, not to encroach on the game play/advertising areas of the ticket 13. This will help for minimal destruction of the play areas when the ticket is opened.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

1. A ticket for a game of chance, comprising:
a strip having a first fold and a second fold, wherein the first fold defines a first panel at an end of the strip and the second fold defines a second panel at another end of the strip and further wherein a third panel is located between the first panel and the second panel;
a play combination located on the third panel, on a first side of the strip; and
game identifying information located on the first panel on a second side of the strip, wherein the first panel is folded over the second panel to form an unopened position.

2. The ticket as set forth in claim 1, further comprising an advertisement located on the second panel.

3. A method of printing a plurality of tickets for a game of chance comprising the steps of:
generating data that includes a randomized plurality of tickets;
providing the data to a printer, wherein the printer does not perform a further randomization of the plurality of tickets; and
printing the plurality of tickets.

4. (canceled)

5. The ticket as set forth in claim 1, wherein the second panel is wider then the first panel.

6. The ticket as set forth in claim 1, wherein the ticket is sealed in the unopened position.

7. The ticket as set forth in claim 6, wherein the ticket is held shut by glue, a crimp or a band.

8. The ticket as set forth in claim 1, wherein the third panel contains more then one play combination.

9. The ticket as set forth in claim 1, further comprising game payout information located on the third panel on the second side of the trip.

10. The ticket as set forth in claim 1, wherein the game is played by unfolding the first panel and the second panel to form an opened position.

11. The ticket as set forth in claim 1, further comprising a blockout area for increasing the opacity of a portion of the strip.

12. The ticket as set forth in claim 1, further comprising additional panels located between the first panel and the second panel.

13. A ticket as set forth in claim 12, wherein a single play combination is spread over several panels.

14. A ticket as set forth in claim 12, wherein each additional panel contains an additional play combination.

15. A ticket as set forth in claim 14, wherein the game of chance has a progressive/digressive play scheme.

16. The ticket as set forth in claim 15, wherein the game of chance has a progressive play scheme in which a condition provided in one panel is met by another game panel results in increased winnings.

17. The method of claim 3, wherein the data includes a complete game of chance.

18. The method of claim 3, wherein the data includes a digital press sheet.

19. The method of claim 3, wherein the step of printing includes a static printing technique.

20. The method of claim 3, wherein the step of printing does not include a static printing technique.

21. A method of printing a plurality of tickets for a game of chance, comprising the steps of:
creating a digital press sheet that includes the plurality of tickets; and
printing the digital press sheet.

22. A method of creating a digital press sheet for a game of chance, comprising the steps of:
choosing play combination symbols;
choosing a rule for the game;
generating data that represents a plurality of game tickets based on the chosen symbols and chosen rule; and
generating the digital press sheet, wherein the digital press sheet includes the generated data that represents the plurality of game tickets and data related to locations of the tickets on the digital press sheet.

23. The method of claim 22, further comprising the step of displaying the digital press sheet on a display device.

24. The method of claim 22, further comprising the step of printing the digital press sheet.

25. The method of claim 22, further comprising the step of generating the data related to the locations of the tickets on the digital press sheet, wherein the locations are randomly chosen.

26. The method of claim 25, wherein the step of generating the data related to the locations of the tickets on the digital press sheet is based on the size of the digital press sheet when printed.
